(19) United States
(12) Patent Application Publication
(10) Pub. No.: US 2008/0109997 A1
(43) Pub. Date: May 15, 2008

(54) Handle For A Cleaning Device

(75) Inventor: Miguel Angel Toral Fernandez, Tarragona (ES)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Carl Freudenberg KG, Weinheim (DE)

(21) Appl. No.: 11/575,454

(22) PCT Filed: Aug. 4, 2005
(86) PCT No.: PCT/EP05/08450

§ 371 Date: Aug. 23, 2007

(30) Foreign Application Priority Data
Sep. 29, 2004 (DE) 10 2004 047 162.2

(51) Int. Cl. B25G 1/04; A47L 1/00

(52) U.S. Cl. 16/429; 15/97.1

(57) ABSTRACT

The invention relates to a handle (1) for a cleaning device (2), which comprises at least one telescope part (4) which is lengthwise variable in the longitudinal direction (3) of the handle (1) and at least one part (5, 6) which is stationary in the longitudinal direction (3) of the handle (1), whereby the telescope part (4) and the stationary part (5, 6) are linked with each other in such a manner that they can be detached without sustaining any damage.

### TECHNICAL FIELD

The invention relates to a shaft for a cleaning device.

### STATE OF THE ART

Shafts for cleaning devices are generally known and formed, for example, by a telescoping shaft. The telescoping shaft comprises, e.g., two continuous telescopic rods that can be pushed one inside the other, wherein a cleaning implement/device is arranged at one end of the telescoping shaft and a handle at the other end of the telescoping shaft.

In the pushed-together state of the telescoping shaft, this has approximately the length of the longest telescopic rod.

Another previously known shaft comprises several stationary parts, which are each connected to each other by a positive and/or non-positive fit.

The length of such shafts can be modified to the conditions of the particular application only in steps depending on the length of the individual stationary parts.

### PRESENTATION OF THE INVENTION

The invention is based on the task of refining a shaft for a cleaning device, such that it can be produced easily and economically in terms of manufacturing and costs, such that the shaft features good durability during a long period of use, such that a part of the length is continuously variable, and such that the shaft is easy to handle for the user and has small packaging dimensions overall.

This task is realized according to the invention by the features of claim 1. The subordinate claims referring directly or indirectly back to claim 1 relate to advantageous constructions.

To achieve the task, a shaft for a cleaning device is provided comprising at least one telescopic part that is variable in its length in the longitudinal direction of the shaft and at least one part that is stationary in the longitudinal direction of the shaft, wherein the telescopic part and the stationary part can be detachably connected to each other in a non-destructive way.

In such a shaft there is the possibility to construct the telescopic part as a handle and to mount the stationary part on the telescopic part on the end toward the surface to be cleaned. The handling of such a shaft is especially simple for the user. In addition, it is advantageous that the mechanism of the telescopic part is protected, for example, from cleaning fluid, due to its arrangement at the top on the shaft. Therefore, the function of the telescopic part is maintained without limitations during a long period of use.

In general, however, there is also the possibility to form the stationary part as a handle and to arrange the telescopic part on the side of the stationary part toward the surface to be cleaned.

Through the combination of the telescopic part that is variable in its length with the stationary part, the shaft can be adapted continuously, as far as the telescopic part allows, to the conditions of the corresponding application, and the shaft has only small packaging dimensions. Due to the small packaging dimensions, the packaging and shipping costs are reduced to a minimum.

The small packaging dimensions are produced in that the telescopic part preferably has a length similar to the stationary part in the completely pushed-together state.

For such a construction, after assembly of the telescopic part with the stationary part, the shaft has a maximum length that is approximately three times the length of the stationary part, given that the telescopic part has two approximately equal-length telescopic rods that can be pushed one inside the other.

In contrast, if three stationary parts were to be used, as is known, for example, from the state of the art, on the one hand, the assembly effort for the user would be greater in that the three stationary parts would have to be connected to each other in two assembly processes, as opposed to one assembly process in which the telescopic part is connected to the stationary part. On the other hand, a shaft made from three stationary parts would have no continuously variable area, which would allow especially good adaptation to the conditions of the corresponding application.

If the shaft were to consist of only one telescopic part with two telescopic rods that could be pushed one inside the other and if it were to have the same maximum length as the previously described shaft according to the invention, it would be disadvantageous in that the telescopic part in the pushed-together state would be significantly longer, resulting in greater packaging dimensions and undesirably high packaging and shipping costs.

In contrast, if the telescopic part were to be embodied, for example, in three parts having three telescopic rods that could be pushed one inside the other, the thinnest telescopic rod must be designed for durability. The thickest telescopic rod would therefore be significantly overdimensioned, would be heavy, and the shaft would have disadvantageous handling.

According to an advantageous construction, only one telescopic part is used which is connected to only two stationary parts. Such a combination is especially advantageous in terms of simple and economic production, good durability, and small length in the disassembled state, which results in small packaging dimensions and small packaging and shipping costs. In addition, the handling of such a shaft is not a problem for the user.

In general there is the possibility that the telescopic part, viewed in the longitudinal direction, is arranged between the two stationary parts. Both the top part of the shaft, on which the cleaning equipment is suspended, for example, and also the bottom part of the shaft, on which the cleaning implement/device is arranged, have no parts that move relative to each other and that are mechanically susceptible to faults as stationary parts.

According to another construction, the telescopic part can form the top handle of the shaft, wherein the two stationary parts attach to the telescopic part longitudinally in the direction of a surface to be cleaned. Through such a construction, the mechanism of the telescopic part is protected to a maximum degree from contact with contaminants and/or cleaning fluid and/or fluid sprays, without requiring expensive sealing measures.

In the pushed-together state, the telescopic part has a length that preferably corresponds to the length of the longest stationary part. The packaging dimensions conform to the longest component of the shaft. Alternatively, it is advantageous for the greatest possible continuous adjustability to be achieved by the telescopic part. The smallest packaging dimensions are achieved, on one hand, by a compact length of the disassembled components of the shaft, and on the other hand, the greatest possible continuous adjustability of the telescopic part is achieved when the telescopic part has a length corresponding to the length of the longest stationary part in the pushed-together state.

Preferably, the two stationary parts also have a matching length. The shaft is therefore embodied in three parts comprising a telescopic part and two stationary parts, wherein the telescopic part in the pushed-together state has the same length as each stationary part. In the assembled state, the shaft then has a length that corresponds at least to three times the length of one of the parts. The maximum length of the shaft corresponds approximately to four times the length of one of the parts, wherein the length is continuously variable between 3 times and 4 times the length of one of the parts.

The two stationary parts can be embodied as equal parts. Here, it is advantageous that the shaft can be produced easily and economically by means of equal parts, and that the handling of the shaft is simplified for the user, especially for the assembly of the individual parts. Assembly errors are therefore reduced to a minimum.

The two stationary parts can be embodied using the same material. For example, they can consist of steel or aluminum or polymer materials.

The two stationary parts preferably have a tubular construction. The shaft therefore has a relatively low weight overall. Handling of the cleaning device is therefore simplified overall.

Preferably, the diameters of the two stationary parts are 15-25 mm. Therefore, a good compromise between low weight and resistance to breaking is guaranteed.

The telescopic part can be formed by only two telescopic rods that can be pushed one inside the other. The diameter differences between the two telescopic rods are only relatively small due to the small number of telescopic rods. In contrast, if the telescopic part were to consist of three or four telescopic rods that could be pushed one inside the other, then the thinnest of the telescopic rods would have to be designed for durability. Therefore, at least the thickest of the telescopic rods would be significantly overdimensioned, and the shaft would be heavy and disadvantageous for handling.

For a two-part telescopic part, the telescopic rods preferably have a diameter of 20-30 mm.

In addition, the invention relates to a cleaning device with a shaft according to one of claims 1-12, wherein the shaft of this cleaning device has the previously described advantages. The cleaning device can be produced easily and economically in terms of manufacturing and cost, has good durability during a long period of use, has variable uses through the variable length of the shaft, and is simple to handle and has small overall packaging dimensions.

### BRIEF DESCRIPTION OF THE DRAWING

Three embodiments of the shaft according to the invention and one embodiment of the cleaning device according to the invention are explained in more detail below with reference to FIGS. 1-3.

These figures each show in a schematic representation:

FIG. 1, a first embodiment of the shaft according to the invention, wherein the shaft comprises only one telescopic part and only one stationary part which are connected to each other.

FIG. 2, an embodiment of the cleaning device according to the invention with a second embodiment of the shaft according to the invention, in which the shaft according to the invention comprises a telescopic part and two stationary parts, wherein the telescopic part, viewed in the longitudinal direction, is arranged between the two stationary parts.

FIG. 3, a third embodiment of a shaft, wherein the telescopic part, in contrast to the shaft from FIG. 2, forms the top handle of the shaft.

### CONSTRUCTION OF THE INVENTION

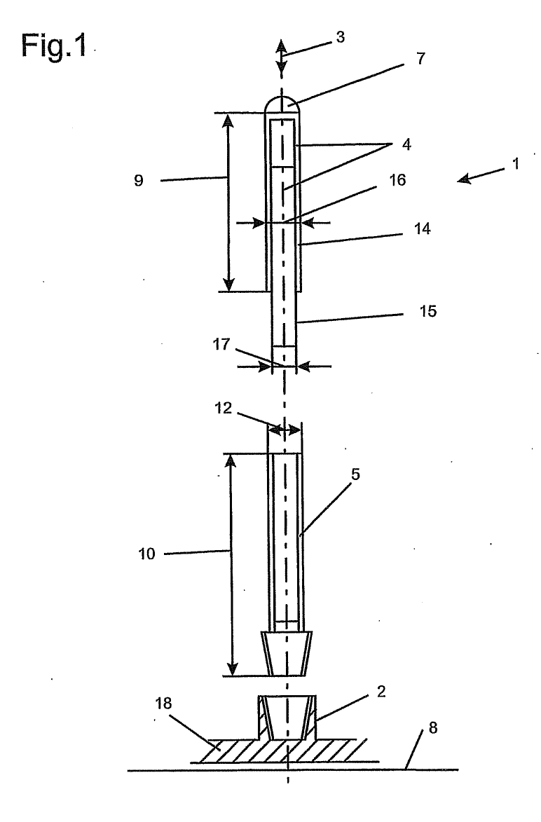

FIG. 1 shows a first embodiment of the shaft 1 according to the invention, that forms, for example, a component of a cleaning device 2. The shaft comprises a telescopic part 4 and a stationary part 5, wherein the telescopic part 4 is variable in its length in the longitudinal direction 3 of the shaft 1. The stationary part 5 has a tubular construction and is detachably connected to the telescopic part 4 in a non-destructive way. The connection of the telescopic part 4 and the stationary part 5 is realized, for example, through a clamping connection or through a screw connection of facing ends of the interconnected parts 4, 5.

In the embodiment shown here, the telescopic part 4 has a length 9 that corresponds to the length 10 of the stationary part 5 in the pushed-together state. The telescopic part 4 comprises only two telescopic rods 14, 15, which can be pushed one inside the other, wherein the thinner of the two telescopic rods 15 is connected to the stationary part 5.

The maximum length of the shaft 1 is approximately three times the length 9 of the telescopic part 4 in the pushed-together state, wherein this length 9 corresponds to the length 10 of the stationary part 5.

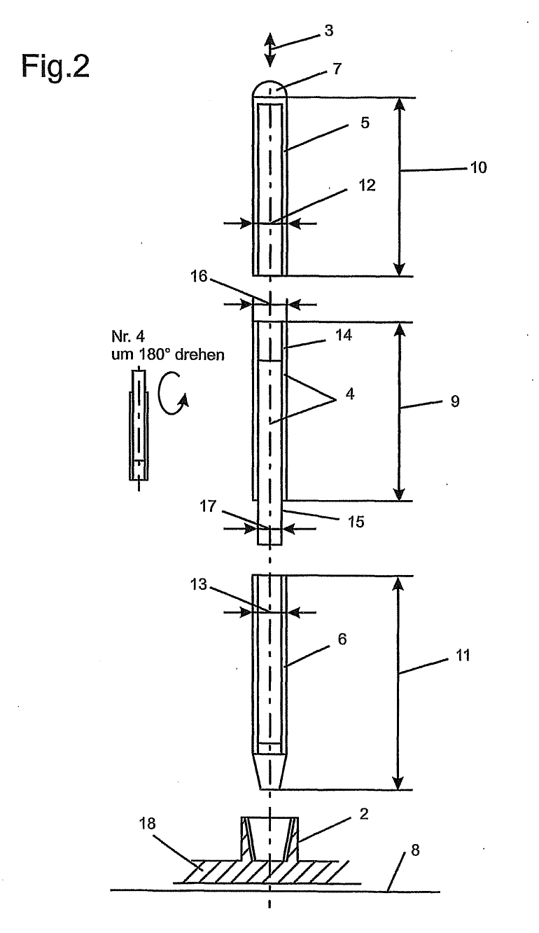

FIG. 2 shows a second embodiment of the shaft 1 and the cleaning device 2 to which the shaft 1 belongs. The cleaning device 2 has a top handle 7 and a wiper plate 18, which is covered with a wiping covering not shown here in more detail, on the side of the shaft 1 remote from the handle 7 in the axial direction.

The shaft 1 has a three-part construction comprising the telescopic part 4 and two stationary parts 5, 6, wherein the two stationary parts 5, 6 are embodied as equal parts and using the same material. The top handle 7 can be generated as a separate component relative to the shaft 1, and can be pushed onto the end of the shaft 1 remote from the wiper plate 18.

Viewed in the longitudinal direction 3, the telescopic part 4 is arranged between the two stationary parts 5, 6. The maximum length of the shaft 1 is approximately four times the length of the telescopic part 4 or one of the stationary parts 5, 6.

The cleaning device shown here can have many variable uses due to the shaft 1 shown here. For example, if a large length of the shaft 1 is necessary, the telescopic part 4 is pulled out completely, wherein each of the telescopic parts 14, 15 is approximately half as long as the completely pulled-out telescopic part 4. In addition, the two stationary parts 5, 6 are fitted, wherein each of the stationary parts 5, 6 has a length similar to the telescopic part 4 in the pushed-together state.

In contrast, if a cleaning device is required that is shorter overall, then there is the possibility of either reducing the length of the telescopic part 4 continuously so that the two telescopic rods 14, 15 are pushed one inside the other and/or so that one of the stationary parts 5, 6 is removed from the shaft 1.

In the embodiment shown here, the telescopic part 4 is embodied such that the telescopic rod 15 having the relatively small diameter 17 is connected to the stationary part 6, to which the wiper plate 18 is also attached, while the telescopic rod 14 with the larger diameter 16 is connected to the stationary part 5, on which the handle 7 is also arranged. The mechanism of the telescopic part 4 is well protected from environmental effects by the guide of the telescopic part 4 which is open in the direction of the handle 7; therefore good functioning of the telescopic part 4 is guaranteed during a long period of use.

In general, the telescopic part 4 can also be mounted between the stationary parts 5, 4 rotated by 180°.

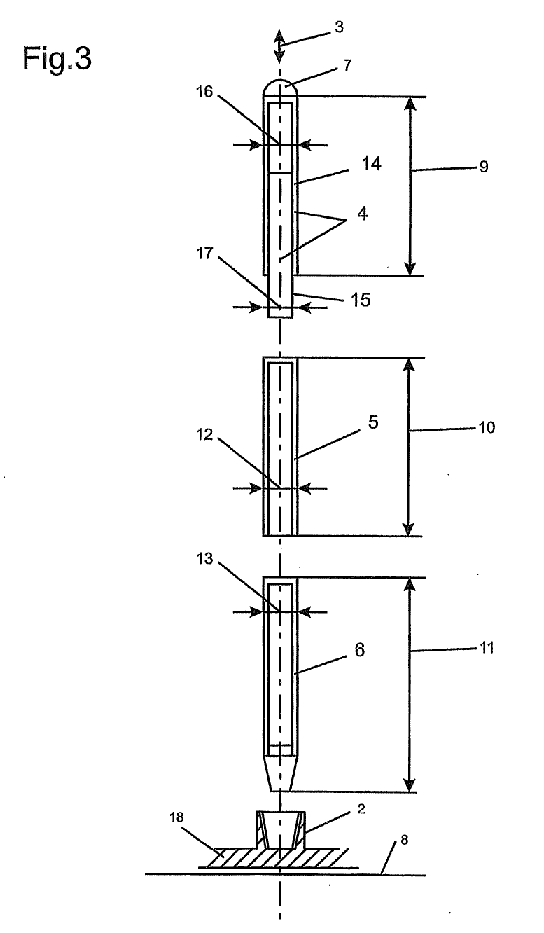

In FIG. 3, a third embodiment of a shaft 1 is shown, similar to the embodiments from FIGS. 1 and 2, wherein the telescopic part 4 forms the top handle 7 of the shaft 1 and wherein the two stationary parts 5, 6 connect to the telescopic part 4 longitudinally in the direction of the wiper plate 18 and the surface 8 to be cleaned.

In this embodiment, only relatively small mechanical loads act on the telescopic part 4 since the force of the user is usually introduced approximately longitudinally in the center of the shaft 1, in order to achieve increased pressure of the wiper plate 18 on the surface 8 to be cleaned.

1. A shaft for a cleaning device comprising at least one telescopic part which is variable in its length in the longitudinal direction of the shaft and which forms the top handle of the shaft, two parts that are stationary in the longitudinal direction of the shaft, in that the telescopic part and the stationary parts are detachably connected to each other in a non-destructive way, and in that the two stationary parts attach to the telescopic part longitudinally in the direction of a surface to be cleaned.

2. The shaft according to claim 1, wherein only one telescopic part is connected to only two stationary parts.

3. The shaft according to claim 1, wherein the telescopic part as a length that corresponds to the length of the longest stationary part in the pushed-together state.

4. The shaft according to claim 1, wherein the two stationary parts have a matching length.

5. The shaft according to claim 1, wherein the two stationary parts are embodied as equal parts.

6. The shaft according to claim 1, wherein the two stationary parts are embodied using the same material.

7. The shaft according to claim 1, wherein the two stationary parts each have a tubular construction.

8. The shaft according to claim 1, wherein the two stationary parts have a diameter amounting to 15-25 mm.

9. The shaft according to claim 1, wherein the telescopic part is formed by only two telescopic rods, which can be pushed one inside the other.

10. The shaft according to claim 9, wherein the telescopic rods have a diameter amounting to 20-30 mm.

11. A cleaning device comprising a wiper plate and a shaft, the shaft comprising at least one telescopic part which is variable in its length in the longitudinal direction of the shaft and which forms the top handle of the shaft, two parts that are stationary in the longitudinal direction of the shaft, in that the telescopic part and the stationary parts are detachably connected to each other in a non-destructive way, and in that the two stationary parts attach to the telescopic part longitudinally in the direction of a surface to be cleaned.
